(19) United States
(12) Patent Application Publication
(10) Pub. No.: US 2017/0172103 A1
(43) Pub. Date: Jun. 22, 2017

(54) Pet Enclosure

(71) Applicant: Yee-Ann Lee, Fremont, CA (US)

(72) Inventor: Yee-Ann Lee, Fremont, CA (US)

(21) Appl. No.: 14/972,777

(22) Filed: Dec. 17, 2015

(51) Int. Cl. A01K 1/03; A01K 1/035; A01K 1/015

(52) U.S. Cl. CPC A01K 1/033; A01K 1/015; A01K 1/0158; A01K 1/0353

(57) ABSTRACT

A housing enclosure has a wall structure defining the enclosure, a first passage through the wall structure providing entry, and an escape door through the wall structure separate from the first passage, the escape door capable of opening only outward from inside the housing enclosure by an outward force against the escape door from within the enclosure.

### BACKGROUND OF THE INVENTION

1. Field of the Invention

The present invention is in the field of pet enclosures and pertains particularly to methods and apparatus for housing an animal, such as a pet cat.

2. Discussion of the State of the Art

In the field of pet enclosures, there is an abundance of dog houses on the market for outdoor use, but there are few attractive and functional options when it comes to outdoor cat houses. Outdoor cats are typically independent, but still need reliable shelter to rest, sleep, and avoid predators and inclement weather. Cat guardians have resorted to homemade, makeshift, or the few commercially available outdoor cat houses in order to shelter outdoor cats, whether feral, stray, or owned (outdoor or indoor-outdoor).

Current enclosures for cats have been mostly limited to those used for transportation or indoor usage, such as carriers, cat trees, scratching structures, or simple plastic/wooden/fabric structures with one or more openings.

It has occurred to the inventor that outdoor cats are different from dogs and indoor cats from the perspective of instinct and safety requirements in general, and that outdoor cats may certainly need an enclosure suited to their particular needs.

Therefore, what is clearly needed is an enclosure for outdoor cats that may offer the cat a dry, warm, and safe unit. Even indoor cats will find such unit appealing. Such an enclosure should also be easy for the cat guardian to disassemble and clean. Furthermore, the unit should be designed to appeal to the cat's natural instincts to maximize usage. And finally, the unit should be designed with aesthetics in mind so that cat guardians are inclined to place these units in visible outdoor locations such as porches, yards, catios, and other places where outdoor cats are found.

### BRIEF SUMMARY OF THE INVENTION

In one embodiment of the invention a housing enclosure is provided, comprising a wall structure defining the enclosure, a first passage through the wall structure providing entry, and an escape door through the wall structure separate from the first passage, the escape door capable of opening only outward from inside the housing enclosure by an outward force against the escape door from within the enclosure.

In one embodiment the housing enclosure, the first passage and the escape door are sized to accommodate an adult cat. Also in one embodiment the enclosure is elongated in a first direction with the wall structure exhibiting a top, opposite sidewalls, a bottom, a front region and a rear wall, and wherein the first passage is at the front region, and the escape door is through the rear wall portion. Also in one embodiment the enclosure is substantially symmetrical about a vertical plane oriented in the first direction. And in one embodiment the enclosure has rounded edges and corners both inside and outside.

In one embodiment the enclosure is formed by separable upper and lower portions joined at an interface, such that the portions may be joined and disjoined for access to within the housing structure. Also in one embodiment the upper portion and the lower portion exhibit facing surfaces enabled by engagement features that align the portions for joining, and that block entry of debris and water when the upper and lower portions are joined. In one embodiment the wall structure is defined by one or more walls of substantial thickness. Also in one embodiment the walls are in some locations hollow. And in one embodiment some hollow walls are filled with insulating material.

In one embodiment of the enclosure the first passage is formed by an opening through a single panel engaged in matching grooves in both the upper and the lower portions near the front region. Also in an embodiment the first passage is formed by two or more panels engaged in grooves at different positions along the first direction, the panels having overlapping edges spaced apart along the first direction in a manner that an animal to enter the housing enclosure through the first passage moves around the edges of and between the spaced-apart panels. Also in one embodiment the front region has an upper canopy extending forward and shading the first passage from rain and falling debris. In one embodiment the first passage is substantially smaller in area than the single panel and is positioned above a lower edge of the panel. And in one embodiment a shelf extends from a lower region of the lower portion below the panel and the first passage, providing a step for an animal to climb up to the first passage.

In one embodiment of the enclosure the first passage includes a flexible, movable covering blocking line-of-sight into the housing enclosure through the first passage. Also in one embodiment the enclosure further comprises a drain opening in a lower region of the wall structure, for draining fluids from the housing enclosure. Also in one embodiment the enclosure further comprises a cushion structure shaped to fit the bottom of the housing enclosure. In one embodiment the cushion comprises a pouch for a heating pad. And in one embodiment the enclosure further comprises a sealed electrical pass-through for power to any electrical device within the housing enclosure.

### BRIEF DESCRIPTION OF THE SEVERAL VIEWS OF THE DRAWINGS

FIG. 1 is a perspective view of a cat enclosure according to an embodiment of the present invention.

FIG. 2 is a front elevation view of the cat enclosure of FIG. 1.

FIG. 3 is a right side elevation view of the cat enclosure of FIG. 1.

FIG. 4 is a rear elevation view of the cat enclosure of FIG. 1.

FIG. 5 is an overhead view of the bottom portion of the cat enclosure of FIG. 1.

FIG. 6 is an overhead view of the top portion of the cat enclosure of FIG. 1.

FIG. 7 is a partial perspective view of the rear of the cat enclosure of FIG. 1 depicting a rear egress door according to an embodiment of the present invention.

FIG. 8 is a view of front wall 104 of the cat enclosure of FIG. 1 with an opening 105 therethrough.

FIG. 9 is an overhead view of cat enclosure 102 of FIG. 1.

### DETAILED DESCRIPTION OF THE INVENTION

In various embodiments described in enabling detail herein, the inventor provides a cat enclosure. The present invention is described using the following examples, which may describe more than one relevant embodiment falling within the scope of the invention.

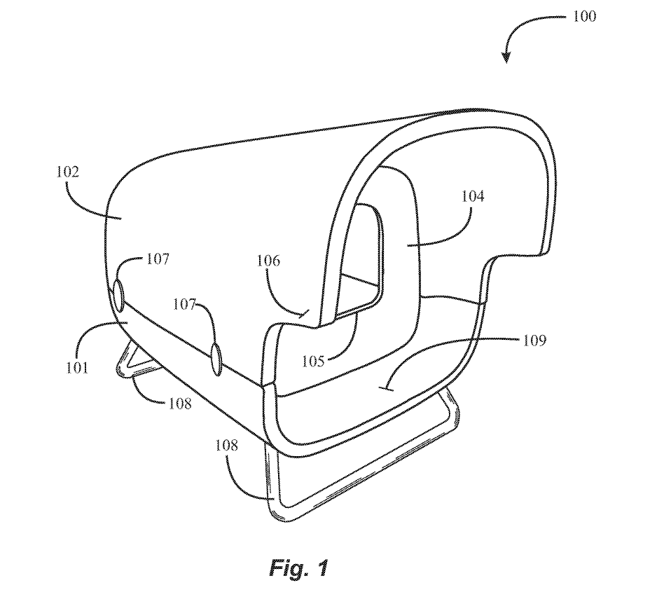

FIG. 1 is a perspective view of a cat enclosure 100 according to an embodiment of the present invention. Cat enclosure 100 is adapted as an outdoor enclosure for a cat. Cat house 100 has two portions that fit together to form the enclosure. Cat enclosure 100 includes a bottom portion 101 and a top portion 102 that are fabricated to fit together and to be secured together in one embodiment using a hinged clasp locking system depicted herein as clasps 107. This two-part construction makes it possible to remove the top portion for inspection and cleaning, and to insert and remove accessories such as cushions and heating pads. Clasps 107 may be similar to clasps used with a lunch box or tool box. Detail relative to clasp architecture is not provided here as one with skill in the art will appreciate that there are varying types of clasps that might be provided and used such as are known to the inventor.

Cat enclosure 100 may be manufactured (typically molded) from a high grade ultraviolet ray resistant polyvinyl chloride (PVC), or from other suitable polymer material, such as polyethylene or high-density polyethylene. In one embodiment the construction is a double-walled material sealed at the edges to trap air within the wall, providing light weight and additional insulation properties to the enclosure. In another embodiment, material may be solid plastic material molded to form the top and bottom fixtures of the enclosure. Clasps 107 enable the top and bottom of the enclosure to be sealed sufficiently to prevent moisture and winds or drafts from entering the enclosure through the sides.

Enclosure 100 in the embodiment illustrated includes at least two leg stands 108. Leg-stands 108 may be manufactured from metal tubing that is resistant to rust, such as stainless steel or aluminum, or may be plastic tubing. Leg stands 108 may in one embodiment be folded onto the bottom surface of bottom 101 of the enclosure when the cat enclosure is not in use or is being transported. In one embodiment, leg-stands 108 are connected to a frame that is fixed and that bottom portion 101 of the enclosure may be fitted onto and perhaps attached to. Leg-stands 108 provide an amount of elevation keeping enclosure 100 off the ground. In one embodiment post type legs may be provided. In a variation of this embodiment the legs may be adjustable in length to raise or lower the elevation of the enclosure off of the ground. In an alternative embodiment the legs may fit into holes provided in the bottom portion of the housing, and a user may bend the upward-extending parts of each leg somewhat, so the legs will exert some pressure on the holes to keep the legs in place. There are indeed a wide variety of ways the legs may be implemented and joined to the body of the cat house.

Top portion 102 of enclosure 100 is greater in overall length than bottom portion 101. This adaptation is depicted by hood extension 106 formed contiguously with the top portion. Hood extension 106 extends out over a front shelf area 109 of the bottom of enclosure 100. Hood extension 106 functions to shade and protect the front area of the enclosure from sun and other weather elements, such as rain and snow.

Enclosure 100 in one embodiment includes a modular front wall 104 that may be inserted into place in bottom 101 of enclosure 100 by virtue of a slot or groove (not illustrated) provided horizontally along the bottom and inner sidewall surfaces of the bottom of the enclosure. Front wall 104 is recessed back into the enclosure a certain distance sufficient to provide shelf area 109 in front of an opening 105 through wall 104 of the enclosure. Opening 105 is positioned in the front wall to be a few inches above shelf area 109. In some embodiments front wall 104 is contiguously molded as a part of top portion 102, or as a part of bottom portion 101. The front wall can also be molded into the top portion and the bottom portion (i.e. top half of front panel molded into top portion while the bottom half of the front panel is molded into the bottom portion).

The overall outer shape of enclosure 100 has a curved shape for both aesthetic and practical purpose. The overall shape of enclosure 100 provides a sleek, radius profile that is more wind resistant than a box shape to deter toppling of the enclosure in stiff winds. In one embodiment bottom 101 of enclosure 100 may be weighted by inclusion of heavy material or objects within or otherwise attached to the bottom of the enclosure.

In the embodiment illustrated entrance opening 105 through wall 104 is a through opening with no door, skirt, or flap covering the entrance. This feature aids in reassuring a cat that entering the enclosure is safe, by enabling the cat to see inside the enclosure from the shelf area before entering. Moreover, opening 105 is elevated above the surface of the shelf area 109, requiring the cat to step over a portion of the front wall when entering. This feature aids in keeping smaller animals and insects from entering the enclosure and also helps to prevent dirt, leaves, and other debris from entering the enclosure. This feature also allows the cat to “hide” better and stay out of sight while inside the cat house. It also keeps rain out since the opening is further away from the ground (by preventing rain from bouncing off of the ground and into the opening).

Although not illustrated in this view, enclosure 100 includes a rear exit opening formed into the top portion, or both the top and bottom portion. This rear exit has a one-way door opening outward. More detail about a rear exit is provided later in this specification. In one embodiment, top 102 may also have a carry handle (not illustrated), which may in some embodiments be a handle that fastens to the upper portion, or may be a handle formed into the body of the upper portion. In one embodiment more than one carry handle may be provided on the top or sides of the enclosure. In one embodiment, enclosure 100 may be placed at a higher elevation owing to a fact that cats are typically not inhibited by height, as dogs and other animals might be. For example, enclosure 100 might be placed on a bench, a table, a shelf, or some other elevated surface. In one embodiment, enclosure 100 may be installed in a tree. Such placement may further reassure a cat of the safety of the enclosure.

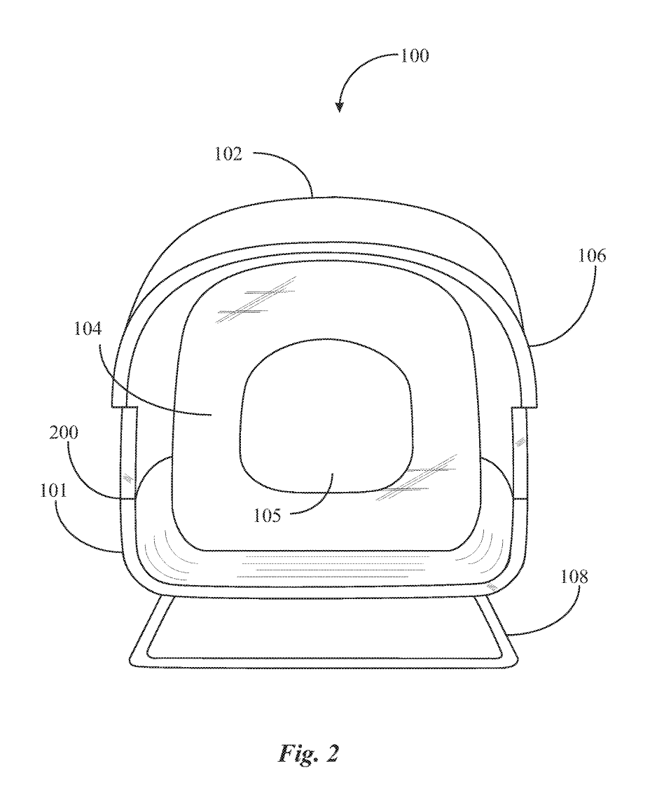

FIG. 2 is a front elevation view of cat enclosure 100 of FIG. 1. Enclosure 100, fully assembled, is in one embodiment slightly higher at the front end than at the rear end. The overall shape of the enclosure formed by the bottom and top portions lends to a rearward slope and amply rounded corners that function to shed water or melting snow to the rear and off of the sides of the enclosure rather than toward the front of the enclosure. Front wall 104 in one embodiment, as described previously, is seated in a slot or groove extending horizontally about bottom portion 101 and, in one embodiment, at least into the sidewalls of top 102 of enclosure 101, and in a preferred embodiment extends all around the periphery of the top and bottom portions, such that the front panel is in a groove in assembly all around the panel. There are other ways to seat front wall 104 into enclosure 100 without departing from the spirit and scope of the invention, and in some embodiments the front wall is contiguously molded into either the top or the bottom portion of the enclosure, and extends into a groove in the opposite portion. The front wall may also be molded into the top portion. The front wall can also be molded into the top portion and the bottom portion (i.e. top half of front panel molded into top portion while the bottom half of the front panel is molded into the bottom portion).

In one embodiment the widest portion of the overall shape of enclosure 100 is at the forward outer surfaces of hood extension 106 of top portion 102. In this view, top 102 and bottom 101 of the enclosure when assembled exhibit an interface line 200. In one embodiment one or more gaskets may be provided and placed on the interfacing surfaces to seal off elements from the outside of enclosure 101. For example, a gasket might be provided to interface between the top portion and bottom portion of the enclosure, and a gasket may be provided within the groove seating front wall 104 without departing from the spirit and scope of the present invention.

Further to the above, in some embodiments, channels may be provided in one or the other of the top and bottom portions around the periphery, with matching ridges provided on the mating opposite portion, such that the two portions fit together and barrier is provided through the mating interface. The top and bottom portions in a preferred embodiment have tracks so they fit together more easily and prevent water and wind from entering the house.

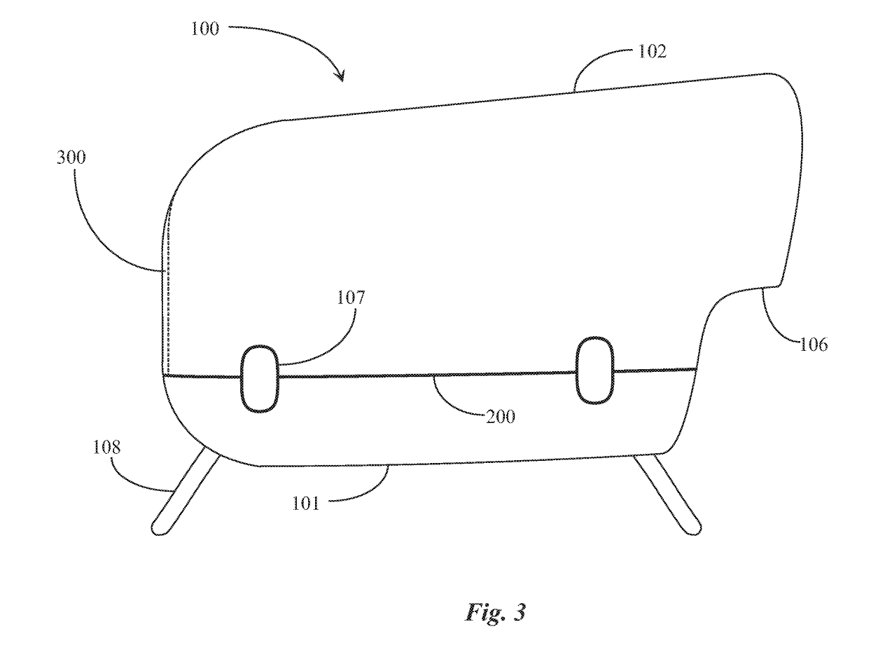

FIG. 3 is a right side elevation view of enclosure 100 of FIG. 1. Enclosure 100 includes a rear door 300 that functions to enable egress out of the enclosure but prevents entrance through the rear of the enclosure. Door 300 may be hinged (not illustrated) at the top of the door and may swing closed under its own weight against a space formed at the rear of the enclosure. In one embodiment a magnet (not illustrated) may be provided on the door or hinge to adhere magnetically to a metal plate or shim installed for the purpose of holding the door closed under magnetic influence. In this embodiment, the magnet used is strong enough to keep the door closed but weak enough to enable the cat to easily open the door to exit the enclosure.,

In this view, the overall shape of the enclosure in this embodiment is evident, including rearward slope and ample corner and side curvature in the assembled components. Referring momentarily back the FIG. 2, the upper curved edges on top portion 102 are larger than those on bottom portion 101, functioning to displace water, deter wind, displace melting snow, and providing structural stability. Overhang 106 extends significantly past the leading edge of bottom portion 101 of enclosure 100 protecting the front wall area from weather influence.

In one embodiment there are four hinged clasps 107, two (not illustrated) on the side opposite in this view. In another embodiment, there are two hinged clasps on one side and the opposite side may be hinged or pinned together without departing from the spirit and scope of the invention. Other ways to connect the two main components 101 and 102 of the enclosure may also be provided and utilized without departing from the spirit and scope of the invention, such as snapping the components together, for example, and sliding the parts together with the aid of grooves and tracks. In an alternative embodiment the top and bottom portions may be held together by magnets.

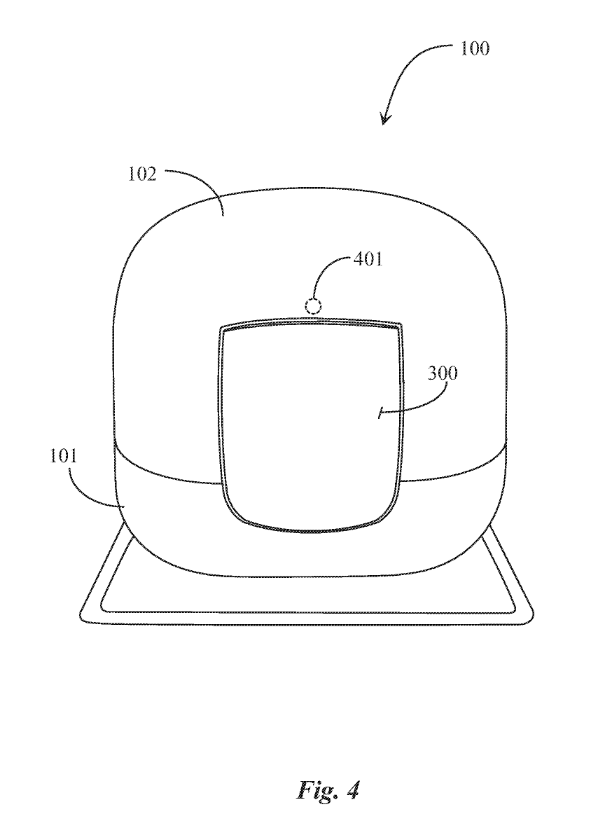

FIG. 4 is a rear elevation view of the enclosure of FIG. 1. Enclosure 100 includes rear egress door 300. In one embodiment door 300 is hinged to or otherwise axially connected to the top of the rear opening provided for the purpose. The opening provided for door 300 in one embodiment is smaller than the door, but has a recessed area that allows the door to close flush with the outer contour of the enclosure.

In one embodiment the opening provided for door 300 has a recessed surface area around at least a portion of the periphery of the through portion of the opening. This enables door 300 to lodge somewhat into the rear surface of the enclosure wherein the inside portion of the door abuts in the closed position against at least one recessed surface, and the outside surface of the door may be even with the outside surfaces of the top and bottom portions of the enclosure.

The rear door in a preferred embodiment rests in a recessed area of the enclosure. The door is held closed by interaction between a small permanent magnet 104 and a magnetically permanent element, one of which is fixed in the upper portion and one of which is fixed in the door. The at least one recessed area prevents door 300 from intruding into enclosure 100 making it useful only for egress or escape from within enclosure 100. A small push from a cat inside the enclosure will dislodge separate the magnetic elements as the door is pushed open, allowing the cat to escape.

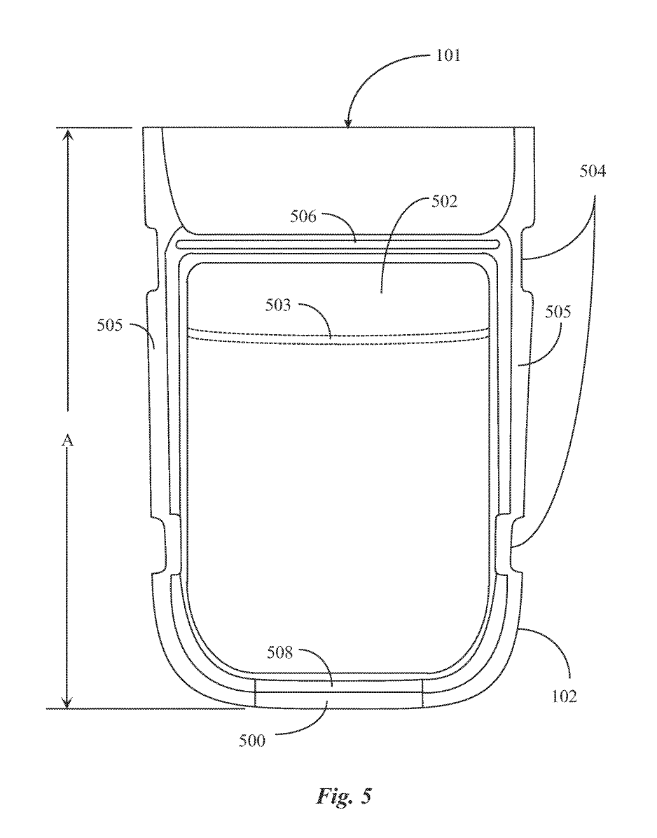

FIG. 5 is an overhead view of bottom portion 101 of cat enclosure 100 of FIG. 1, with the top portion removed. Clasp hardware is also removed from this view to better illustrate details of the bottom wall structure of bottom portion 101. Bottom portion 101 includes a drain opening 501. Drain opening 501 includes a through opening and a counter-bored surface that may accept a screen plug or solid plug to prevent entry into the enclosure through the drain opening from below.

A slot or groove 506 in one embodiment is provided horizontally into and along at least the bottom wall of bottom portion 101, the groove or slot extending at least partially up each inner sidewall of bottom portion 101. Slot 506 has a depth and a width. The depth is sufficient to seat a modular front wall structure such as front wall 104 of FIG. 1. At the sidewalls the depth dimension of groove 506 plus the inside diameter from inner wall to inner wall is just larger than the widest point on the modular front wall so it may be easily inserted. Further, in one embodiment the inner wall of the groove is higher than the outer wall of the groove, to prevent water from seeping into the house.

The width of slot 506 is just larger than the thickness of the modular front wall, allowing the front wall to be inserted into the groove and held relatively stable and upright. In one embodiment slot 506 extends further into the inner side walls of top portion 102 (not illustrated). In one embodiment the material of the sidewalls of bottom 101 is thicker or built up at the location of the groove to provide ample material thickness for accepting the depth of the groove.

In one embodiment slot 506 is molded into the bottom wall and sidewalls of bottom portion 101 and into the top and sidewalls of top portion 102, to extend all around enclosure 100. In an alternative embodiment there may be a ridge extending around both the top and bottom portions with a groove implemented in the ridge. The molded feature relative to the opposing sidewalls of bottom 101 may be accomplished using pins or rails strategically aligned vertically with the slot in the bottom to host the thickness of the front wall section higher up.

Bottom portion 101 includes clasp hardware seat features 504 that may be molded along with other features of enclosure 100, or that may be machined after molding, depending upon hardware requirements. In this embodiment the interfacing surface of bottom portion 101 includes a stepped-down portion (lower surface) 505 that may be molded or created via machining or milling after molding. The fabrication of or mold inclusion of surface 505 creates a ridge or elevated surface 507 on the inner portion of the interfacing wall surface. The top portion of the enclosure then opposing features relative to features 505 and 507 enabling a snug fit of the top portion onto the bottom portion of the enclosure with little or no drift.

In one embodiment the bottom and top of the enclosure are fitted together with a pin and hole alignment system. In still another embodiment, each interfacing wall surface (top and bottom) fits together flush and drifts until the portions are clasped together, the clasps functioning to provide sufficient alignment. Insertion of the modular front wall into the bottom of the enclosure may also aid in aligning the top to the bottom during assembly. The overall length A of bottom portion 101 of the enclosure is shorter than the overall length of the top piece (102) by virtue of the overhang extension (106) on the top piece discussed further above.

Bottom portion 101 in one embodiment includes a step-down feature 500 representing a lower surface than the rear door opening. The door is removed for clarity. Surface 500 leaves a ridge 508 for the door to abut against when closed. In this example, there is an accessory pad 502 provided to fit in the bottom of enclosure 101. The pad in a preferred embodiment is of the shape of the inside of bottom portion 101, and the pad fills the floor of the bottom portion. Pad 502 in one embodiment may include a pocket 503 adapted to accept an electric heating pad. The heat pad may be integrated with the cushion in other ways, and the opening may be at top edge or bottom edge of the cushion. There may be a zipper or other closure as well.

In one embodiment there may be partitions molded into the surface of bottom portion 101 to define where pillow 502 will fit and to prevent drift of the pillow. In one embodiment a heating pad in pocket 503 may be wired through drain opening 501 to a source of power. Drain 501 may be screened or otherwise obstructed by fixturing in one embodiment to prevent snakes or harmful creatures from invading the cat enclosure from below.

In one embodiment a power pass-through may be provided in bottom portion 101 such that the heating pad, or any other desirable electrically-powered device, may be connected on the inside, and a power line may be connected on the outside. In another embodiment a battery, that may be rechargeable, may also be provided with the enclosure, perhaps in a molded portion, to provide power for electrically-powered devices.

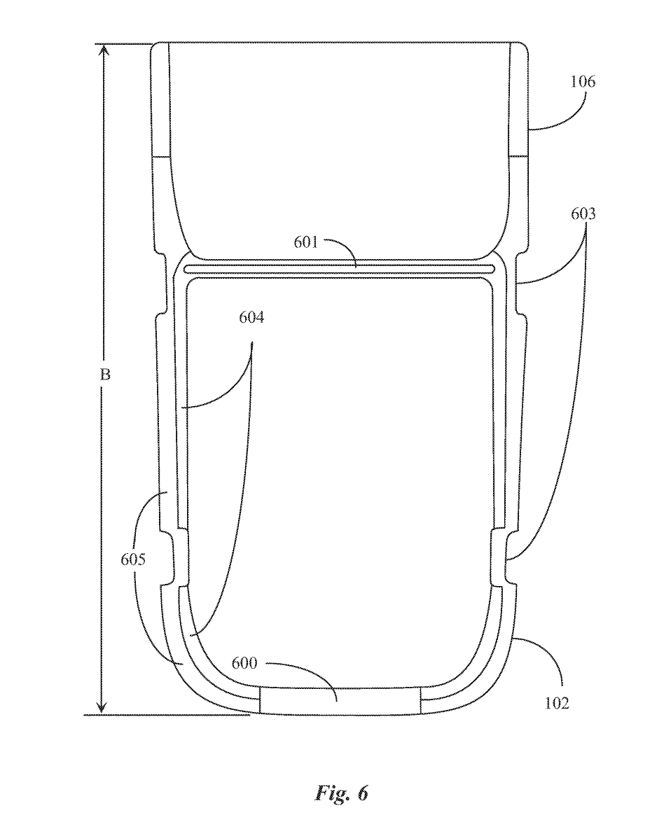

FIG. 6 is an overhead view of top portion 102 of the enclosure 100 of FIG. 1. Clasp hardware is removed from this view to better illustrate the surface area of the top interfacing surface structure of top portion 101. A groove 601 is provided in this embodiment and extends completely up the sidewalls and across the top of top portion 102, and similarly down the sidewalls and across the bottom of bottom portion 101, so, with the top and bottom portions together, the groove is continuous around the inner surface of the joined portions. Groove 601 has a depth and a width. The depth is sufficient to seat a modular front wall structure 104 of FIG. 1. Groove 601 is an extension of groove 506 of FIG. 5. When the enclosure is assembled the slots line up and hold the front wall of the enclosure in rigid order.

In this embodiment the interfacing surface of top portion 102 includes a stepped-down portion (lower surface) 604 that may be molded or created via machining or milling after molding. The fabrication of surface 604 creates a ridge 605 on the outer portion of the interfacing wall surface (opposite configuration) of bottom portion 101. The bottom portion of the enclosure has opposing features enabling a snug fit of the top onto the bottom of the enclosure with little or no drift.

Length B represents the overall length of the enclosure when assembled and may vary accordingly depending upon design considerations. For example, a larger breed of cat, an overweight cat or a cat with certain disposition as assessed by breed may require more than average space. In one embodiment the overall length B is about 27 inches while the overall width may be smaller. In one embodiment the dimensions are more square or length and width being near the same dimension. In one embodiment the cat enclosure may be larger for housing two cats simultaneously. The overall height of the cat enclosure may also vary accordingly and is typically held sufficiently under the length dimension to prevent top heaviness.

Although there are no additional molded features illustrated in top 102, there may be certain features like pockets, compartments, or snap features that may be provided to host an accessory item that may be needed inside the enclosure, such as a deodorizer stick, a catnip supply, a scratch pad, etc. Such features may be molded into the enclosure or assembled onto the enclosure post molding. Such features might also be implemented outside the enclosure, such as a scratchpad on the roof of the enclosure.

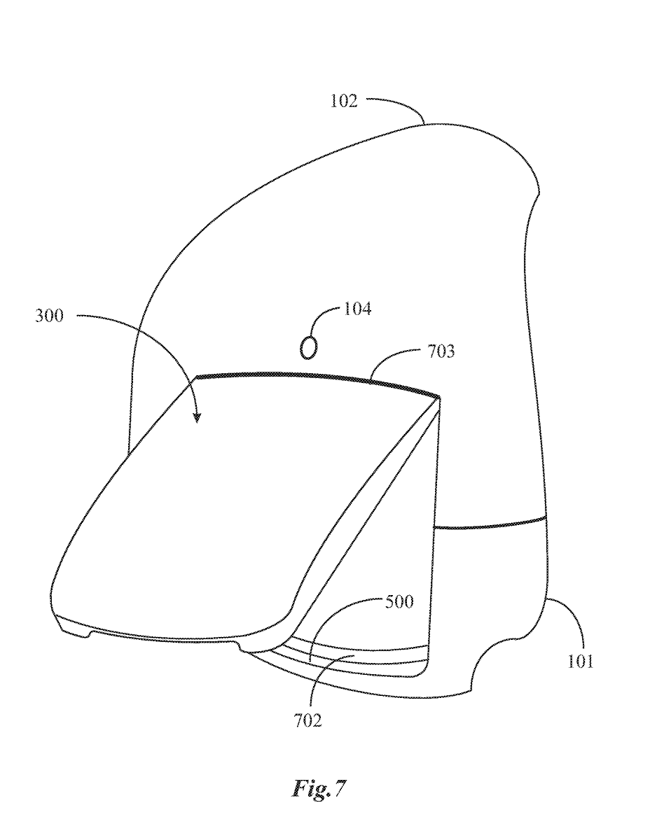

FIG. 7 is a partial perspective view of the rear of cat enclosure 100 of FIG. 1 depicting rear door 300 according to an embodiment of the present invention. Door 300 as previously described is a one-way door opening out to enable only egress from within the enclosure. Door 300 may be molded from UV resistant PVC or another resilient material. In this example bottom portion 101 includes a lower surface 500 and a lip 702 against which door 300 rests when closed. In one embodiment a magnet element 104 interacts with a magnetically permeable element to keep door 300 closed. The magnet and permeable element may be variously placed to interact to keep the door closed until pushed from the inside of the enclosure. In another embodiment door 300 may be adapted to remain closed under tension from one or more springs where upon a force applied against the door from the inside of the enclosure may overcome the spring tension causing the door to swing open.

In one embodiment, the top edge 703 of the door may extend into and upward around the inside of the top portion 102 to form a barrier against rain or wind. In one embodiment, the top edge (703) of door 300 may be adapted to be axially pinned into opposing recesses (not illustrated) near the top of the door opening. In this embodiment a magnet and metal plate or one or more spring mechanisms might also be provided and used to keep the door firmly closed until sufficient force from inside opens the door. In one embodiment door 300 may be recessed into the enclosure somewhat to further protect the inside of the enclosure from outside weather or debris or certain animals that may attempt to pry it open from the edges.

In one embodiment there may be a gasket or weather stripping material applied about the door opening to help seal the door. In such an embodiment a magnet may be used to hold the door somewhat firmly against the gasket or weather stripping. In one embodiment door 300 may be weighted at or near the bottom edge of the door to give it some more weight to help it stay closed with or without a magnet. In one embodiment, door 300 may contain a window (not illustrated). In one embodiment door 300 may be detached from top portion 102 during transportation or storage, or when training a cat to use the rear exit.

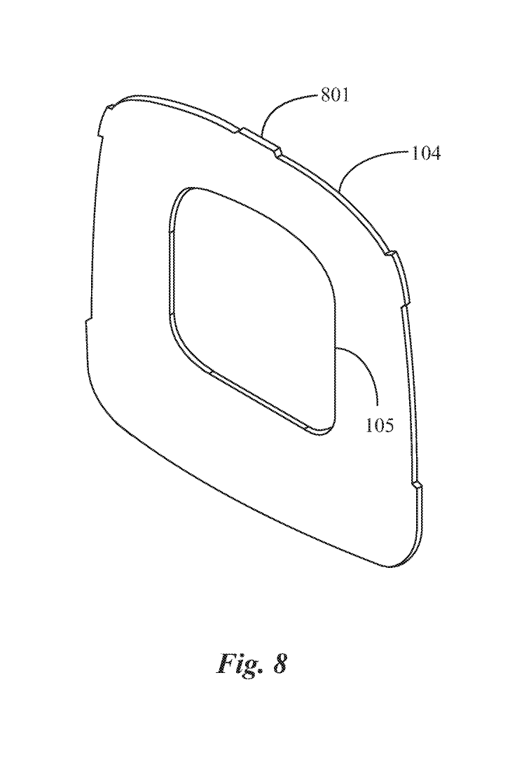

FIG. 8 is a view of front wall 104 of the cat enclosure of FIG. 1 in one embodiment with an opening 105. In this embodiment the edges of front wall 104 have several equally-spaced tabs 801 that may engage in a continuous groove in the inside area of the upper portion, or may engage in separate indentions placed for engaging the tabs. Front wall 104 may be removed from enclosure (100) by first detaching the top portion from the bottom portion of the enclosure and then pulling the front wall out of its host groove. In one embodiment there may be more than one modular front wall to the enclosure such as one with a smaller opening and one with a larger opening, or with openings placed differently or having different shapes. Door 300 and modular front wall 104 may be molded separately from the enclosure portions. In one embodiment a flexible fabric curtain, a soft plastic sheet or maybe even a rigid swinging door might be provided to partially shield or camouflage opening 105 and to provide more privacy for a cat inside the enclosure.

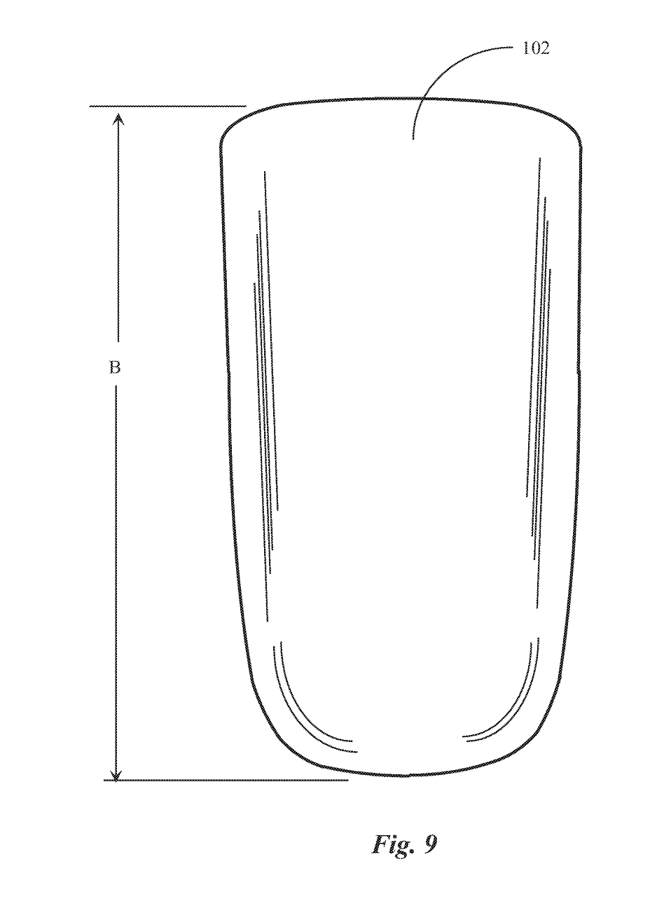

FIG. 9 is an overhead view of the top portion 102 of the cat enclosure of FIG. 1. Top portion 102 has a generally bullet-shaped profile. It is noted herein that the bullet profile includes a slight taper down from front to rear and large corner curvature to aid in directing moisture and debris off of the top of the enclosure and back from the top front of the enclosure.

The longer length B of top portion 102 is an important feature for preventing weather elements from entering the enclosure through the modular front wall and opening. Hood extension 106 provides the added length past the forward edge of the bottom (101) of the enclosure.

It will be apparent to one with skill in the art that the cat enclosure system of the invention may be provided using some or all of the above-described features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention. For example, in one embodiment all the interior corners/edges are curved. This makes it easier when wiping and rinsing and it's more ergonomic for cats. Also, the size of the house is also optimal for comfort and retaining body heat.

It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A housing enclosure, comprising:
a wall structure defining the enclosure;
a first passage through the wall structure providing entry; and
an escape door through the wall structure separate from the first passage, the escape door capable of opening only outward from inside the housing enclosure by an outward force against the escape door from within the enclosure.

2. The housing enclosure of claim 1, wherein the housing enclosure, the first passage and the escape door are sized to accommodate an adult cat.

3. The housing enclosure of claim 1, wherein the enclosure is elongated in a first direction with the wall structure exhibiting a top, opposite sidewalls, a bottom, a front region and a rear wall, and wherein the first passage is at the front region, and the escape door is through the rear wall portion.

4. The housing enclosure of claim 3, wherein the enclosure is substantially symmetrical about a vertical plane oriented in the first direction.

5. The housing enclosure of claim 4, having rounded edges and corners both inside and outside.

6. The housing enclosure of claim 5, wherein the enclosure is formed by separable upper and lower portions joined at an interface, such that the portions may be joined and disjoined for access to within the housing structure.

7. The housing enclosure of claim 6, wherein the upper portion and the lower portion exhibit facing surfaces enabled by engagement features that align the portions for joining, and that block entry of debris and water when the upper and lower portions are joined.

8. The housing enclosure of claim 1, wherein the wall structure is defined by one or more walls of substantial thickness.

9. The housing enclosure of claim 7, wherein the walls are in some locations hollow.

10. The housing enclosure of claim 8, wherein some hollow walls are filled with insulating material.

11. The housing enclosure of claim 6, wherein the first passage is formed by an opening through a single panel engaged in matching grooves in both the upper and the lower portions near the front region.

12. The housing enclosure of claim 6, wherein the first passage is formed by two or more panels engaged in grooves at different positions along the first direction, the panels having overlapping edges spaced apart along the first direction in a manner that an animal to enter the housing enclosure through the first passage moves around the edges of and between the spaced-apart panels.

13. The housing enclosure of claim 3, wherein the front region has an upper canopy extending forward and shading the first passage from rain and falling debris.

14. The housing enclosure of claim 11, wherein the first passage is substantially smaller in area than the single panel and is positioned above a lower edge of the panel.

15. The housing enclosure of claim 14, wherein a shelf extends from a lower region of the lower portion below the panel and the first passage, providing a step for an animal to climb up to the first passage.

16. The housing enclosure of claim 11 wherein the first passage includes a flexible, movable covering blocking line-of-sight into the housing enclosure through the first passage.

17. The housing enclosure of claim 1 further comprising a drain opening in a lower region of the wall structure, for draining fluids from the housing enclosure.

18. The housing enclosure of claim 3 further comprising a cushion structure shaped to fit the bottom of the housing enclosure.

19. The housing enclosure of claim 18 wherein the cushion comprises a pouch for a heating pad.

20. The housing enclosure of claim 3 further comprising a sealed electrical pass-through for power to any electrical device within the housing enclosure.
